(19) United States
(12) Patent Application Publication
(10) Pub. No.: US 2018/0282200 A1
(43) Pub. Date: Oct. 4, 2018

(54) METHOD OF MANUFACTURING COUPLED-CORE MULTI-CORE FIBER

(71) Applicant: SUMITOMO ELECTRIC INDUSTRIES, LTD., Osaka (JP)

(72) Inventors: Tetsuya NAKANISHI, Yokohama-shi (JP); Takuji NAGASHIMA, Yokohama-shi (JP)

(73) Assignee: SUMITOMO ELECTRIC INDUSTRIES, LTD., Osaka (JP)

(21) Appl. No.: 15/936,802

(22) Filed: Mar. 27, 2018

(30) Foreign Application Priority Data
Mar. 28, 2017 (JP) 2017-063650

(51) Int. Cl. C03B 37/04; C03B 37/018; C03C 25/005; G02B 6/02

(52) U.S. Cl. CPC C03B 37/044; C03B 37/018; C03C 25/005; G02B 6/02042; G02B 6/03627; G02B 6/02333; C03B 2203/34; C03B 2205/06; G02B 6/02314

(57) ABSTRACT

A coupled-core multi-core fiber in which an inter-core distance is stabilized is manufactured. A method of manufacturing a coupled-core multi-core fiber includes forming a second cladding base material by depositing glass particulates on an outer periphery of a first cladding base material and sintering the glass particulates. The first cladding base material has a hydroxyl group concentration that is less than or equal to 10 ppb; obtaining a ground rod by grinding an outer periphery of the second cladding base material; and forming holes in the first cladding base material in the ground rod, inserting a core base material into each of the holes, and obtaining an assembly.

### BACKGROUND OF THE INVENTION

### Field of the Invention

The present invention relates to a method of manufacturing a coupled-core multi-core fiber.

### Description of the Related Art

Japanese Unexamined Patent Application Publication No. 2005-350328 describes a method of manufacturing an optical fiber preform. In the method, a core rod is made from a glass soot deposited body formed by vapor phase axial deposition (VAD) and is formed with a predetermined outside diameter. Subsequently, glass soot is deposited on the core rod by performing outside vapor deposition method and the glass soot is sintered.

A coupled-core multi-core fiber is one in which spatial mode dispersion (SMD) between a plurality of cores is suppressed by intentionally causing crosstalk to occur between the plurality of cores as a result of disposing the plurality of cores close to each other such that the distance between the plurality of cores is a predetermined distance (refer to Tetsuya Hayashi et al., 125-μm-cladding Coupled Multi-core Fiber with Ultra-low Loss of 0.158 dB/km and Record-low Spatial Mode Dispersion of 6.1 ps/km^{1/2}, OFC Th5A. January 2016).

### SUMMARY OF THE INVENTION

When the manufacturing method that is described in Japanese Unexamined Patent Application Publication No. 2005-350328 is applied to manufacturing a coupled-core multi-core fiber, the distance between the cores may vary in the longitudinal direction of the optical fiber due to deformation of the core rod caused by contraction of the glass soot deposited body during the sintering process. Variations in the distance between the cores are not desirable because this causes the SMD of the coupled-core multi-core fiber to increase and, thus, transmission characteristics to deteriorate. In addition, since the cores do not exist at predetermined positions, connection loss is increased during connection.

Accordingly, it is an object of the present invention to provide a method of manufacturing a coupled-core multi-core fiber, which allows a coupled-core multi-core fiber having little variations in the distance between cores to be stably manufactured.

A method of manufacturing a coupled-core multi-core fiber according to the present invention includes forming a second cladding base material by depositing glass soot on an outer periphery of a first cladding base material and sintering the glass soot, the first cladding base material having a hydroxyl group concentration that is less than or equal to 10 ppb; obtaining a ground rod by grinding an outer periphery of the second cladding base material; forming holes in the first cladding base material in the ground rod; and obtaining an assembly by inserting a core base material into each of the hole, in this order. In the assembly, the core base material is still not yet integrated with the first cladding base material and the second cladding base material. The core base material may be formed from only a center core in which light propagates, or may be formed from a center core in which light propagates and an optical cladding that surrounds a periphery of the center core.

The method of manufacturing a coupled-core multi-core fiber according to the present invention may include directly drawing the assembly in which the core base material is still not yet integrated with the first cladding base material and the second cladding base material. In this case, the core base material may contain an alkali metal.

The method of manufacturing a coupled-core multi-core fiber according to the present invention may include, after cleaning an interface between the first cladding base material and the core base material of the assembly, obtaining an optical fiber preform by heating and integrating the first cladding base material and the core base material; and drawing the optical fiber preform.

Even in the case where the assembly is directly drawn or the optical fiber preform is temporarily obtained and is drawn, the method of manufacturing a coupled-core multi-core fiber includes maintaining the coupled-core multi-core fiber during spinning at a temperature that is greater than or equal to a certain temperature.

According to the present invention, there is provided a method of manufacturing a coupled-core multi-core fiber, which allows a coupled-core multi-core fiber in which an inter-core distance is stabilized to be manufactured.

### BRIEF DESCRIPTION OF THE DRAWINGS

FIG. 1 is a sectional view of a coupled-core multi-core fiber that is manufactured by a method of manufacturing a coupled-core multi-core fiber according to an embodiment of the present invention, the sectional view being perpendicular to a fiber axis.

FIG. 2 is a graph of refractive indices of the coupled-core multi-core fiber shown in FIG. 1 along arrow A.

FIG. 3 is a flow diagram for describing the method of manufacturing a coupled-core multi-core fiber according to the embodiment of the present invention.

FIG. 4 is a conceptual view for describing the method of manufacturing a coupled-core multi-core fiber according to the embodiment of the present invention.

FIG. 5 illustrates a drawing tower.

FIG. 6 is a conceptual view of a modification of a core arrangement.

FIG. 7 is a conceptual view of a modification of a refractive index distribution.

### DESCRIPTION OF THE PREFERRED EMBODIMENTS

Specific examples of a method of manufacturing a coupled-core multi-core fiber (may be referred to as “coupled-core MCF”) according to the present invention are described below with reference to the drawings. The present invention is not limited to such exemplifications. The present invention is intended to be defined by the scope of the claims, and to encompass meanings equivalent to the scope of the claims and all changes within the scope of the claims.

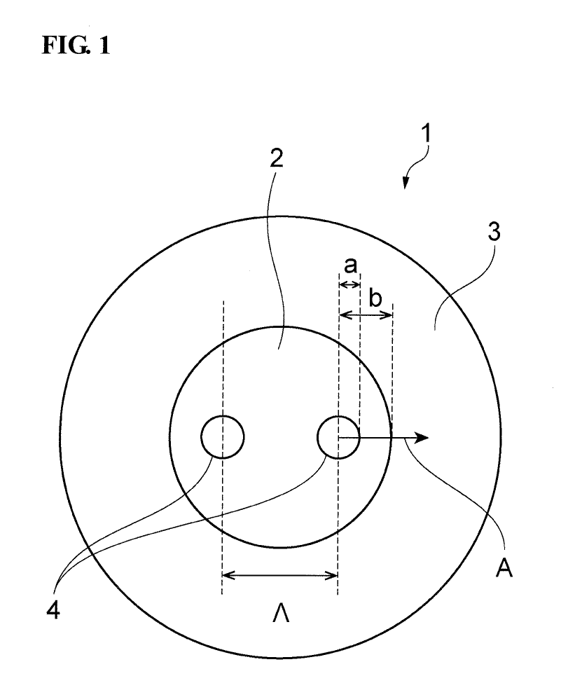

FIG. 1 is a sectional view of a coupled-core MCF 1, which is an example of a coupled-core MCF that is manufactured by the method of manufacturing a coupled-core MCF according to the present invention, the sectional view being perpendicular to a fiber axis. The coupled-core MCF 1 includes a first cladding 2, a second cladding 3 that is provided outwardly of the first cladding 2, and a plurality of cores 4 that are disposed in the first cladding 2. The diameter of each core 4 is 2a. The distance between the center of each core 4 and an outer periphery of the first cladding 2 is b. Each core 4 extends in a fiber axis direction. An inter-core distance (a distance between the centers of the cores 4) is A. Although, in the coupled-core MCF 1, two cores 4 are provided in the first cladding 2, the number of cores in the coupled-core MCF that is manufactured by the method of manufacturing a coupled-core MCF according to the present invention is not limited to two.

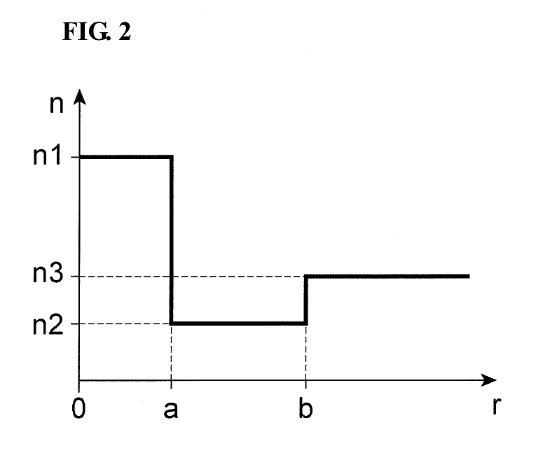

FIG. 2 is a graph of refractive indices of the coupled-core MCF 1 along arrow

A. The abscissa represents a distance r from the center of a core 4 and the ordinate represents a refractive index n. When the distance r is smaller than a, the refractive index is n1 of each core 4. When the distance r is between a and b, the refractive index is n2 of the first cladding 2. When the distance r is larger than b, the refractive index is n3 of the second cladding 3. Although, in the coupled-core MCF 1, the refractive indices of the core 4, first cladding 2, and the second cladding 3 have a relationship n1>n3>n2, the relationship between the refractive indices in the coupled-core MCF that is manufactured by the method of manufacturing a coupled-core MCF according to the present invention is not limited to the aforementioned relationship. Although the sectional shape of each core 4 is a circular shape, the sectional shape is not particularly limited to certain shapes. The diameters of the plurality of cores 4 may or may not be the same. The refractive indices of the plurality of cores 4 may or may not be the same. However, it is desirable that a core structure be one that performs a so-called single mode operation in which the number of propagation modes is one. The present invention can also be applied to a coupled-core MCF that presupposes a few-mode operation in which the number of propagation modes is more than one.

The first cladding 2, the second cladding 3, and the cores 4 are each made of silica glass, serving as a main component, to which an additive for adjusting the refractive index may be added as appropriate. However, the hydroxyl group concentration of the first cladding 2 is 10 ppb or less. When the hydroxyl group concentration of the first cladding 2 existing around the cores 4 is 10 ppb or less, it is possible to suppress absorption loss caused by the first cladding 2. The hydroxyl group concentration of the second cladding 3 that is provided around the outer periphery of the first cladding 2 is not specified as it is for the first cladding 2, and may be changed as appropriate.

Although each core 4 may be made of, for example, pure silica glass, each core 4 may contain an alkali metal. Examples of the alkali metal that is contained in each core 4 include lithium (Li), sodium (Na), potassium (K), and rubidium (Rb). Although each core 4 may contain only one of the types of the aforementioned alkali metals, each core 4 may contain more than one of the types of the aforementioned alkali metals at the same time. When each core 4 contains an alkali metal, it is possible to reduce attenuation when the coupled-core MCF 1 has been manufactured by a particular manufacturing method. This point is described later.

In the coupled-core MCF 1, the distance between the centers of the two cores 4 is specified as being the inter-core distance A. According to the method of manufacturing the coupled-core MCF 1 of the embodiment, it is possible to manufacture the coupled-core MCF 1 in which variations in the inter-core distance A along the fiber axis direction are suppressed.

A covering layer, formed from a resin material, may be formed to cover the second cladding 3 of the coupled-core MCF 1. The diameters and arrangements of the first cladding 2, the second cladding 3, and the cores 4, and the thickness and material of the covering layer may also be changed as appropriate in accordance with the use of the coupled-core MCF.

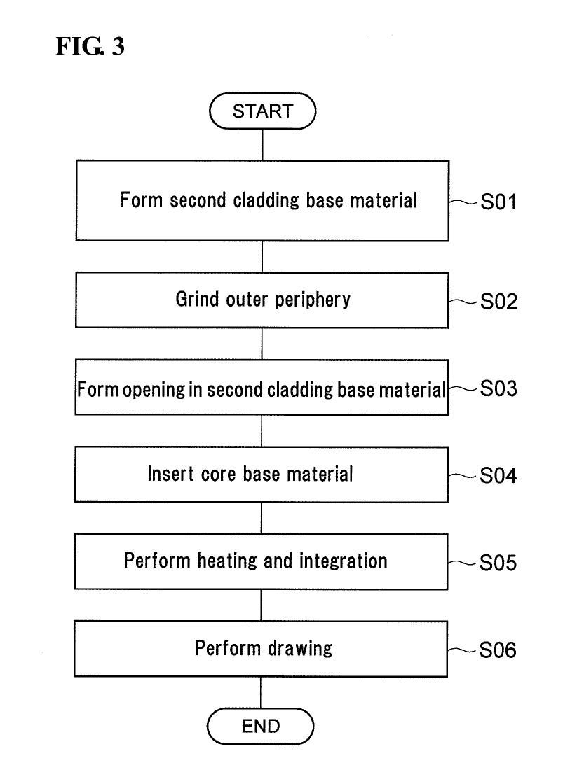

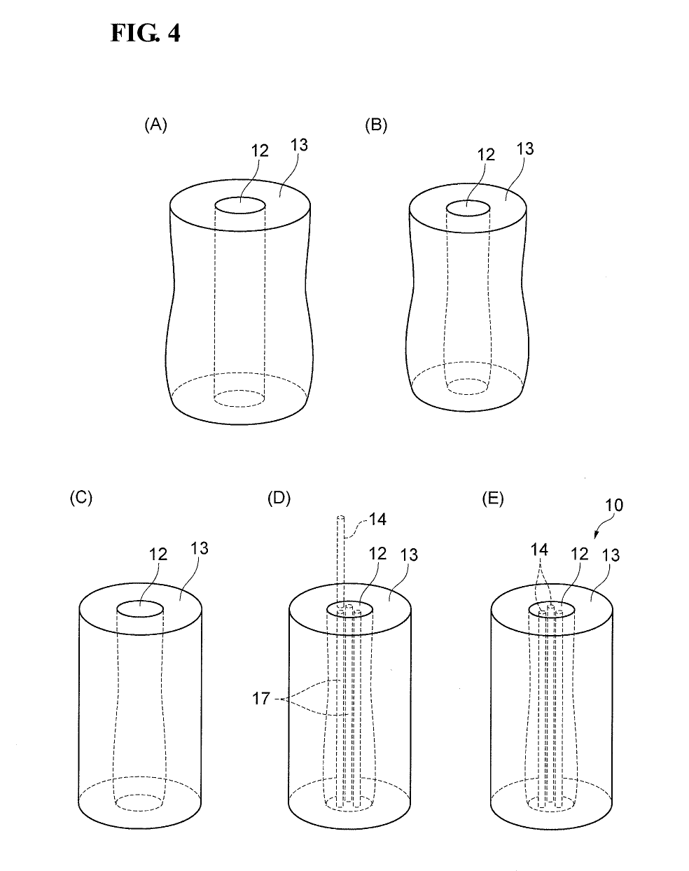

FIG. 3 is a flow diagram for describing the method of manufacturing a coupled-core MCF according to the embodiment. FIG. 4 is a conceptual view and includes area (A) to (E), each of which describes each step of the method of manufacturing a coupled-core MCF.

First, as a first cladding base material 12, which becomes the first cladding 2, a material having a hydroxyl group concentration of 10 ppb or less is selected. As shown in area (A) of FIG. 4, glass soot formed by introducing a glass raw material, such as silicon tetrachloride, into a heating range of an oxyhydrogen flame burner is deposited on an outer periphery of the first cladding base material 12 to form a deposit, which becomes a second cladding base material 13. Thereafter, by sintering this under a desired temperature, as shown in area (B) of FIG. 4, a sintered body formed from the first cladding base material 12 and the second cladding base material 13 is formed (S01). The sintered body may have recesses and protrusions formed in a side surface thereof. The recesses and protrusions result from contraction of the first cladding base material 12 and the second cladding base material 13 during the sintering.

Next, an outer periphery of the second cladding base material 13 is ground such that an outer peripheral shape and dimensions thereof are the same as those of an optical fiber preform or an assembly, to obtain a ground rod (S02). As a result, as shown in area (C) of FIG. 4, the outer periphery of the second cladding base material 13 after the sintering can be made smooth with the recesses and protrusions at the outer periphery thereof removed.

Next, as shown in area (D) of FIG. 4, holes 17 are formed along the fiber axis direction in the first cladding base material 12 in the ground rod (S03). A core base material 14 is inserted into each of the holes 17 (S04). This causes an assembly 10 for manufacturing the coupled-core MCF (area (E) of FIG. 4) to be obtained. Here, the core base material may be formed from only a center core in which light propagates, or may be formed from a center core in which light propagates and an optical cladding that surrounds a periphery of the center core.

Regarding the assembly 10 obtained in the insertion step, it is possible to clean a portion between the first cladding base material 12 and the core base material 14 and, then, perform heating to integrate the core base material 14 with the sintered body, formed from the first cladding base material 12 and the second cladding base material 13, and to use this as an optical fiber preform (S05). The expression “clean” refers to removing impurities from an interface between the first cladding base material 12 and the core base material 14 by heating with a halogen gas containing, for example, chlorine and/or fluorine flowing through each of the holes 17 in which the core base material 14 has been inserted. The expression “heating and integration” refers to integrating the core base material 14 with the sintered body, formed from the first cladding base material 12 and the second cladding base material 13, by heating the core base material 14 and the sintered body. By the cleaning, it is possible to obtain the optical fiber preform in which the impurities at the interface between the first cladding base material 12 and the core base material 14 have been removed. On the other hand, when the step related to the heating and integration (S05) is omitted, it is possible to simplify the manufacturing process of the coupled-core MCF.

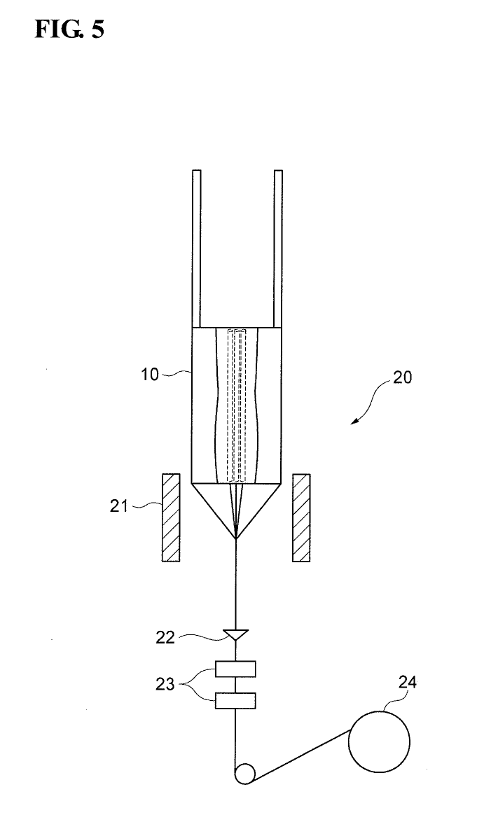

Thereafter, the assembly 10 or the optical fiber preform is drawn (S06). As a drawing method, an existing and publicly known method of drawing an optical fiber preform may be used. FIG. 5 schematically shows a drawing tower 20 that draws an optical fiber preform. The drawing tower 20 includes a heating furnace 21, dies 22, an ultraviolet (UV) furnace 23, and a take-up bobbin 24.

First, the optical fiber preform is softened by heating it in the heating furnace 21. Then, the optical fiber preform is spun by drawing the optical fiber preform at a predetermined take-up speed by using the take-up bobbin 24, and becomes an optical fiber (coupled-core MCF). Thereafter, the optical fiber passes through the dies 22, its surface is coated with a UV curable resin, and this is irradiated with UV rays in the UV furnace 23, so that a covering formed from the UV curable resin is formed on the surface of the fiber. The fiber with the covering on its surface is taken up by the take-up bobbin 24.

A structure that performs slow cooling by using a slow-cooling heating furnace that is separately provided so as to follow the heating furnace 21 and so as to precede the dies 22 may be provided. The slow-cooling heating furnace is a furnace that heats the optical fiber at a heating temperature that is lower than the heating temperature at the heating furnace 21. By causing the optical fiber that has been softened by being heating at the heating furnace 21 and that has been spun to pass through the slow-cooling heating furnace, a sudden reduction in the temperature of the optical fiber is suppressed. Due to the effect of this slow cooling, structural relaxation of glass progresses, so that it is possible to reduce attenuation in the cores 4 of the coupled-core MCF 1 after the manufacturing thereof. The heating temperature at the slow-cooling heating furnace and the amount of time for heating the optical fiber at the slow-cooling heating furnace are set as appropriate in accordance with the material and size of the optical fiber and the drawing speed.

When the step related to the heating and integration (S05) is to be performed, it takes a long time to cool the core base material 14 after the heating step for the integration because the heat capacities of the first cladding base material 12 and the second cladding base material 13 are large. As a result, when the glass making up the core base material 14 contains an alkali metal, crystallization of the glass making up the core base material 14 may be accelerated.

On the other hand, when a manufacturing process that does not use the step related to the heating and integration of the assembly 10 (S05) and that integrates the core base material with the first cladding base material 12 and the second cladding base material 13 for the first time during the drawing, the cores 4 in the optical fiber are cooled at a very high speed. Therefore, since the crystallization of the glass does not progress even if the amount of alkali metal added to the core base material 14 is increased, it is possible to reduce attenuation in the coupled-core MCF 1 after the manufacturing thereof by forming the cores 4 out of a material containing an alkali metal such that the structural relaxation of the glass during the drawing is sufficiently accelerated.

When the average value of the amount of alkali metal that is contained in each core 4 of the coupled-core MCF 1 after the spinning is greater than or equal to 0.1 atom ppm, it is possible to obtain the effect of accelerating the structural relaxation of the glass during the drawing by using an alkali metal, and to obtain the coupled-core MCF 1 in which attenuation is reduced. When the average value of the amount of alkali metal that is contained in each core 4 of the coupled-core MCF 1 after the spinning is greater than or equal to 0.5 atomic ppm, the effect of suppressing the attenuation in the coupled-core MCF 1 is further increased. The expression “atomic ppm” refers to the number of dopant atoms in 1,000,000 units of SiO₂. For example, when the alkali metal is potassium (K), “atomic ppm” indicates the ratio of the number of K atoms to the number of SiO₂ molecules regardless of the form of coupling in glass. This also applies to Li, Na, or Rb, or Cl or F.

Here, the results of evaluating a coupled-core MCF manufactured by the method of manufacturing the coupled-core MCF 1 described in the above-described embodiment are described. First, a coupled-core MCF according to an example and a coupled-core MCF according to a comparative example were manufactured such that, in each coupled core MCF after the manufacturing thereof, a relative refractive index difference Al of cores 4 was 0.32% (in the present specification, the value and signs of the relative refractive index difference Al of the cores having the refractive index n1 are determined by the formula Δ1=(n1-n3)/n1×100, with reference to the refractive index n3 of a second cladding), the diameter 2a of each core 4 was 11.1 μm, the distance between the center of each core 4 and an outer periphery of a first cladding 2 was 10.1 μm, and the inter-core distance A was 28 μm.

As in the description of the embodiment above, in forming the coupled-core MCF according to the example, an assembly or an optical fiber preform was manufactured as a result of, after sintering a second cladding base material, forming holes and inserting a core base material therein. On the other hand, in forming the coupled-core MCF according to the comparative example, holes were formed in a first cladding base material to which a second cladding base material was not yet added, a core base material was inserted therein, and integration was performed. Then, after depositing glass soot corresponding to the second cladding base material on a periphery of the first cladding base material in which the core base material had been inserted, sintering was performed to manufacture an optical fiber preform. The number of cores 4 was two. Regarding the example and the comparative example, the spinning speed was 1300 m/min, and the spinning tension was 80 to 100 g. The outside diameter of each fiber was 125 μm.

Regarding each of the coupled-core MCF according to the example and the coupled-core MCF according to the comparative example, each being obtained by using the above-described method corresponding thereto, in a section that excludes a drawing starting end and a drawing ending end and that extends 500 km in total, the inter-core distance A was measured every 50 km to calculate the maximum value, the minimum value, the average value, and the degree of variability of the inter-core distance. The results are shown in the table. The degree of variability refers to the ratio of the difference between the maximum value and the minimum value to the average value expressed in percent.

TABLE

| | Average | Maximum | Minimum | Degree of |
|---|---|---|---|---|
| | Value | Value | Value | Variability |
| | [μm] | [μm] | [μm] | [μm] |
| Comparative | 28.4 | 29.5 | 27.1 | 8.5 |
| Example | | | | |
| Example | 28.1 | 28.4 | 27.9 | 1.8 |

As shown in the table, it was confirmed that the degree of variability of the inter-core distance in the coupled-core MCF according to the example was smaller than that of the inter-core distance in the coupled-core MCF according to the comparative example.

Hitherto, after forming holes in the first cladding base material 12 and inserting the core base material 14 into each of the holes, these are heated to integrate them. Then, glass soot, which become the second cladding base material 13, are deposited the periphery of the first cladding base material 12, and sintering is performed to form the second cladding base material. That is, with the core base material 14 inserted in the first cladding base material 12, the sintering is performed. Therefore, the core base material 14 is influenced by deformation of the first cladding base material 12 and the second cladding base material 13 caused by contraction of these cladding base materials during the sintering, and is, thus, also deformed. That is, when viewed in the fiber axis direction, the core base material 14 is displaced in the optical fiber preform. In this case, even in an optical fiber that is manufactured by drawing the optical fiber preform, the cores 4 are displaced.

When the optical fiber is a single-core optical fiber in which the core base material exists in the center of the preform, since the position of the core of the optical fiber after the spinning does not move, manufacturing problems do not arise. However, when, as in a coupled-core MCF, a plurality of cores are included within a section of the optical fiber, and the cores are displaced from their design core positions in the section during the formation of the preform, the inter-core distance after the spinning deviates from its design value. This causes spatial mode dispersion to be increased, or connection loss caused by the cores not being at their predetermined positions for connection.

In contrast, according to the method of manufacturing a coupled-core MCF according to the embodiment, after forming the second cladding base material around the outer periphery of the first cladding base material by sintering, holes are formed in the first cladding base material and the core base material is inserted therein, so that an assembly or an optical fiber preform is obtained. When such a manufacturing method is used, since the core base material is not inserted during the sintering of the second cladding base material 13, the core base material is not influenced by contraction of the first cladding base material 12 and the second cladding base material 13 caused by the sintering. Therefore, since deformation of the core base material 14 of the assembly or the optical fiber preform is suppressed, it is possible to suppress variations in the inter-core distance in the fiber axis direction in the coupled-core MCF and to manufacture the coupled-core MCF in which the inter-core distance is stabilized.

When the assembly that is obtained by performing the core base material insertion step is directly drawn, the heating and integration step is simplified/eliminated when compared with an existing step. Therefore, the coupled-core MCF in which the inter-core distance is stabilized can be manufactured simply and economically. Under the above-described conditions, by forming the core base material so as to contain an alkali metal, structural relaxation of glass during the manufacturing is accelerated. Consequently, it is possible to suppress attenuation.

After cleaning the interface between the core base material and the first cladding of the assembly obtained by performing the core base material insertion step, the heating and integration step in which the first cladding and the core base material are integrated with each other to form an optical fiber preform is performed and, then, the optical fiber preform is drawn. This makes it is possible to prevent an increase in attenuation caused by impurities at the interface between the first cladding and the core base material. In this way, when the optical fiber preform is drawn after performing the heating and integration step including the cleaning, if the cores 4 are made of, for example, pure silica, it is possible to manufacture a coupled-core MCF whose attenuation at a wavelength of 1550 nm is less than or equal to 0.175 dB/km.

When, in the drawing step, slow cooling that maintains an optical fiber during spinning at a temperature that is greater than or equal to a certain temperature is performed, the cooling speed of the optical fiber is lessened and reduced in the drawing step than in a case in which the optical fiber after being heated is air-cooled. Therefore, it is possible to reduce attenuation.

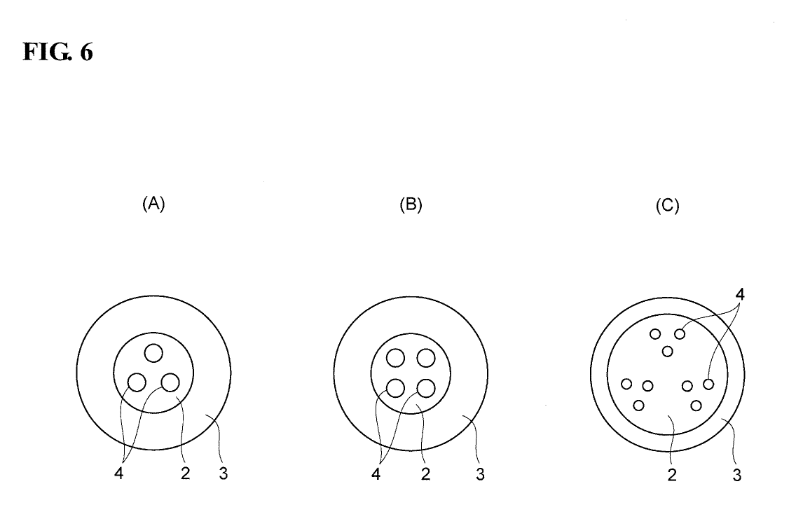

The present invention is not limited to the above-described structure, so that various changes can be made. For example, the core arrangement of a coupled-core MCF to which the present invention can be applied may be changed as appropriate. FIG. 6 is a conceptual view of a modification of the core arrangement of the coupled-core MCF. In the modification shown in area (A), three cores 4 are arranged in the first cladding 2 that is covered therearound by the second cladding 3. In the modification shown in area (B), four cores 4 are arranged in the first cladding 2 that is covered therearound by the second cladding 3. In the modification shown in area (C), three sets of three cores 4, that is, a total of nine cores 4, are arranged in the first cladding 2 that is covered therearound by the second cladding 3. In this way, the core arrangement in the coupled-core MCF may be changed as appropriate.

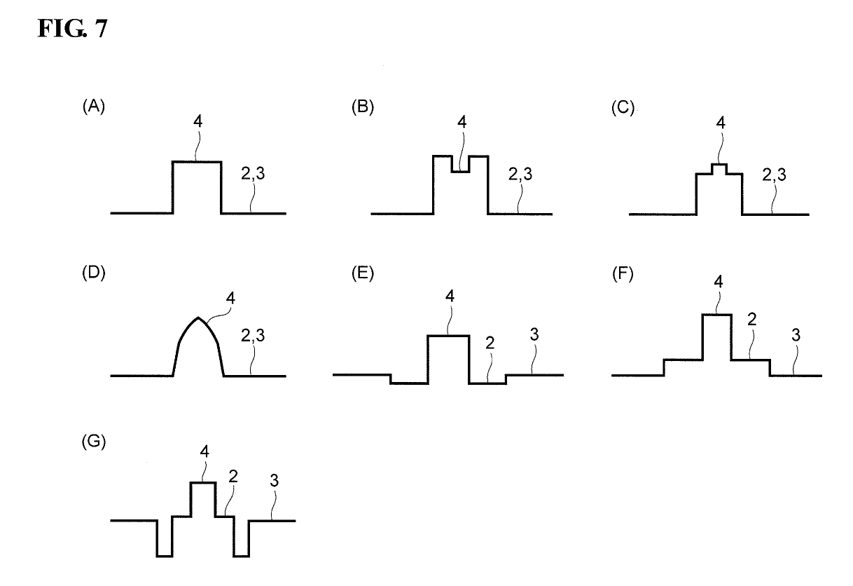

Although, in a coupled-core MCF to which the present invention can be applied, the first cladding 2 and the second cladding 3 are disposed in this order around the cores 4, the relationship between the refractive indices of the cores 4, the first cladding 2, and the second cladding 3 may be changed as appropriate. FIG. 7 is a conceptual view showing changes in the refractive indices of the cores 4, the first cladding 2, and the second cladding 3 of the coupled-core MCF. In each of areas (A) to (G), the refractive index of each core 4 is indicated at the center, and the refractive index of the first cladding 2 and the refractive index of the second cladding 3 are indicated in this order on both sides of the refractive index of each core 4.

Characteristic exemplary refractive indices are described below. For example, as shown in areas (A) to (D), the refractive index of the first cladding 2 and the refractive index of the second cladding 3 may be the same. As shown in area (D), the refractive index of each core 4 may differ at an inner portion from an outer portion (indicated by an inclined line). As shown in area (G), for example, the refractive index of the second cladding 3 may vary. Accordingly, the relationship between the refractive indices of the cores 4, the first cladding 2, and the second cladding 3 may be changed as appropriate. Other optical characteristics of the cores 4, the first cladding 2, and the second cladding 3 may be selected/set as appropriate in accordance with the use of the coupled-core MCF.

What is claimed is:

1. A method of manufacturing a coupled-core multi-core fiber, comprising:
forming a second cladding base material by depositing glass soot on an outer periphery of a first cladding base material and sintering the glass soot, the first cladding base material having a hydroxyl group concentration that is less than or equal to 10 ppb;
obtaining a ground rod by grinding an outer periphery of the second cladding base material;
forming holes in the first cladding base material in the ground rod; and
obtaining an assembly by inserting a core base material into each of the holes.

2. The method of manufacturing a coupled-core multi-core fiber according to claim 1, further comprising:
drawing the assembly.

3. The method of manufacturing a coupled-core multi-core fiber according to claim 2, wherein
the core base material contains an alkali metal.

4. The method of manufacturing a coupled-core multi-core fiber according to claim 1, further comprising:
after cleaning an interface between the first cladding base material and the core base material of the assembly, obtaining an optical fiber preform by heating and integrating the first cladding base material and the core base material; and
drawing the optical fiber preform.

5. The method of manufacturing a coupled-core multi-core fiber according to claim 2, wherein
the drawing step includes maintaining the coupled-core multi-core fiber during spinning at a temperature that is greater than or equal to a certain temperature.

6. The method of manufacturing a coupled-core multi-core fiber according to claim 4, wherein
the drawing step includes maintaining the coupled-core multi-core fiber during spinning at a temperature that is greater than or equal to a certain temperature.
